(19) United States
(12) Patent Application Publication
(10) Pub. No.: US 2008/0048565 A1
(43) Pub. Date: Feb. 28, 2008

(54) Method for Generating a Cold Plasma for Sterilizing a Gaseous Medium and Device Therefor

(76) Inventor: Henri Drean, Paris (FR)

Correspondence Address: SHOEMAKER AND MATTARE, LTD, 10 POST OFFICE ROAD - SUITE 110, SILVER SPRING, MD, 20910, US

(21) Appl. No.: 10/530,814

(22) PCT Filed: Apr. 16, 2003
(86) PCT No.: PCT/FR03/01222

§ 371 Date: Oct. 5, 2006

(30) Foreign Application Priority Data
Apr. 25, 2002 (FR) 02/05227

(51) Int. Cl. H05B 31/26; H05B 41/24

(52) U.S. Cl. 315/111.71; 315/246

(57) ABSTRACT

The invention concerns a method for generating a cold plasma for sterilizing a gaseous medium and a device therefor. The inventive device comprises a confinement chamber (1) including at least one treatment chamber (40), means (4) for generating a first uniform magnetic field (B1), means (5) for generating a second uniform magnetic field (B32), means (6, 7) for emitting an electromagnetic signal (EM1), means (9, 10) for generating one or several second electromagnetic fields (E2) in the plasma and a powering system (14) controlling the value of the first and second magnetic fields (B1, B2) and the frequency and the amplitude of the alternating current voltages (V6, V7).

The invention relates to a method for generating a multipolar gyromagnetic electron cyclotron resonance (ECR) type plasma intended for treating gaseous media containing contaminant particles.

The invention also relates to a device for generating such a plasma.

The term electron cyclotron resonance (ECR) describes the phenomena wherein an electron, in a uniform electrical field, is subjected to centripetal acceleration under the effect of a magnetic field, the plane of the orbit created by this centripetal acceleration being roughly perpendicular to the vector representing the electrical field. If the velocity of the electron has a directional component roughly parallel to the vector representing the magnetic field, the path of the electron will be helical in the direction of the vector representing the magnetic field. It is known from the prior art that an electron passing through a magnetic field and an alternating electrical field with the vector of the electrical field perpendicular to the vector of the magnetic field and with the frequency of the electrical field equal to the frequency of the ECR system, will have its kinetic energy increased during its orbital or helical path. Normally, these methods and devices of the prior art describing these phenomena concern unipolar or bipolar ECR systems (U.S. Pat. No. 5,653,811 and No. 5,841,237).

The term gyromagnetism describes a magnetic field in a defined volume of the space, wherein the vector representing the value of the magnetic field and its direction rotates periodically. An example of gyromagnetic field is a field resulting from the addition of a first nonvarying magnetic field and a second varying magnetic field, where the vector representing the second magnetic field varies periodically between two directions not parallel to the direction of the vector representing the first nonvarying magnetic field. Gyromagnetism is known from the prior art, in particular in the fields of magnetic resonance design and of communications where the principles of gyromagnetism are used in microwave antennas.

The object of the present invention is to produce a multipolar ECR system wherein the magnetic field created is gyromagnetic and wherein the free electrons are produced by a cold plasma, this plasma inducing ionization of the gaseous medium and a considerable increase in reactivity within this gaseous medium. The invention also lies in the application of this system to the treatment of gaseous media containing contaminant particles.

To this end, the method for generating, in the gaseous medium, a multipolar gyromagnetic electron cyclotron resonance (ECR) type plasma comprises the following steps:
the creation, in a confinement chamber, of a standing magnetic field B with a high degree of uniformity, the vector representing the standing magnetic field B being located along a longitudinal axis X-X′ passing through the confinement chamber, the value of this standing magnetic field B being variable,
the creation of the plasma in the confinement chamber 1, in the presence of the standing magnetic field B, by the emission in the gaseous medium of an electromagnetic signal EM1, EM2, this emission being obtained by the application of at least one alternating voltage, the frequency and the amplitude of which are variable,
the creation of at least one first variable electrical field E1 in the plasma by the application of at least one alternating voltage, this alternating voltage having a variable amplitude and frequency and the vector representing the first electrical field E1 being located on an axis perpendicular to the longitudinal axis X-X′,
the creation of at least one second electrical field E2 in the plasma by the application of at least one alternating voltage, the amplitude and the frequency of this alternating voltage being approximately equal to the amplitude and the frequency of the alternating voltage generating the electrical field E1 and the vector representing the second electrical field E2 being located on an axis not parallel to the axis on which the vector of the first electrical field E1 is located,
the application of electrical signals for controlling the value of the standing magnetic field B, the frequency and the amplitude of the alternating voltages generating the electrical fields E1, E2 and the electromagnetic fields EM1, EM2, the application of these electrical signals being used to create (i) an electron cyclotron resonance (ECR) wherein the axis of the centripetal acceleration orbit of the electrons and of the other charged particles is parallel to the longitudinal axis X-X′ (ii) of the electron cyclotron resonances (ECR) wherein the axes of the centripetal acceleration orbits of the electrons and of the other charged particles oscillate gyromagnetically.

Furthermore, the plasma generated by the method is a cold plasma.

According to the invention, the standing magnetic field (B) with a high degree of uniformity generated by the method comprises:
a first uniform magnetic field B1, the field lines of which pass through a first closed curve located in a plane perpendicular to the longitudinal axis X-X′ and centered on this axis,
a second uniform magnetic field B2, the field lines of which pass through a second closed curve located in the same plane as the plane containing the first closed curve, the second closed curve being located inside the first closed curve.

Furthermore, the arc of the angle formed by the vector representing the first electrical field E1 created by the application of the alternating voltage and by each vector representing the or each second electrical field E2 created by the application of the alternating voltage is between 60 and 120°.

Preferably, the amplitudes and the frequencies of the alternating voltages generating the electrical fields E1, E2 and the electromagnetic signals EM1, EM2 are approximately equal.

The method of the invention is applied to the decontamination of the ambient air and of any other gaseous medium, by destroying and/or transforming the atoms and molecules that make up the contaminants present in the ambient air or in the gaseous medium, by the electromagnetic and electromechanical energy of the plasma.

The contaminants present in the gaseous medium are made up of one of the following types or a combination of the latter: microbic aerosols comprising pathogenic micro-organisms such as bacteria, spores, viral and retroviral particles, pathogenic proteinic agents such as prions; volatile and aromatic organic compounds, chlorofluorocarbons, various oxidizable and oxidizing elements such as oxygen, nitrogen and sulfur; ozone; and fibers and particles originating from dust and smoke.

Furthermore, the air or any other contaminated gaseous medium can be probed manually or automatically to determine the presence and the quantity per unit of volume of the various contaminants, before introducing the gas stream into the abovementioned confinement chamber.

Furthermore, the information or data concerning the presence or the quantity per unit of volume of contaminants in the ambient air or in the gaseous medium is used to control the electrical signals.

The multipolar gyromagnetic electron cyclotron resonance (ECR) type plasma-generating device comprises:
a gaseous medium confinement chamber 1 comprising at least one treatment chamber 40 which comprises at its upstream end a first perforated transverse plate 2a made of an electrically conductive material, a first perforated wall 3a made of an electrically insulating material and opaque to the electromagnetic signals, fixed to the upstream side of the first perforated plate 2a, a second perforated transverse plate 2b made of an electrically conductive material fixed to the upstream side of the first perforated wall 3, a second perforated transverse wall 3b made of an electrically insulating material and opaque to the electromagnetic signals fixed to the upstream side of the second perforated plate 2b and a third perforated transverse wall 32 parallel to the first perforated plate 2a and axially spaced from the latter to delimit the confinement chamber, the third perforated wall made of an electrically insulating material and opaque to the electromagnetic signals, and situated at the downstream end of the treatment chamber 40 to allow the gas stream to leave through the third perforated wall,
a means 4 for generating a first uniform magnetic field B1, the vector representing this first magnetic field B1 being parallel to the longitudinal axis X-X′ of the treatment chamber 40, this longitudinal axis X-X′ passing through the center of the first perforated plate 2 and the third perforated wall 32,
a means 5 for generating, in the treatment chamber 40, a second uniform magnetic field B2 in the first uniform magnetic field B1, the vector representing the second magnetic field B2 being parallel to and having the same direction as the vector representing the first uniform magnetic field B1,
a means 6,7 for emitting an electromagnetic signal EM1 in the gaseous medium of the treatment chamber 40 to produce free electrons in this gaseous medium, by the application to this means 6,7 of at least one alternating voltage V6; V7,
a means 9, 10 for generating a first uniform electrical field E1 in the plasma, by the application to this means 9, 10 of at least one alternating voltage V6; V7, the amplitude and the frequency of which can be variable and the axis on which is located the vector representing the first uniform electrical field E1 being perpendicular to the longitudinal axis X-X′ of the treatment chamber 40,
a means 12, 13 for generating one or more second electrical fields E2 in the plasma, by the application to this means 12, 13 of a first alternating voltage V6 and the axis on which is located the vector representing each second electrical field E2 not being parallel to the axis on which is located the vector representing the first uniform electrical field E1,
a powering system 14 controlling the value of the first and second uniform magnetic fields B1, B2, the frequency and the amplitude of the alternating voltages V6; V7 and of the first alternating voltage V6, this powering system (14) being used to generate (i) an electron cyclotron resonance (ECR) wherein the axis of the centripetal acceleration orbit of the electrons and of the charged particles is parallel to the axis X-X′ of the treatment chamber 40 (ii) of the electron cyclotron resonances (ECR), wherein the axes of the centripetal acceleration orbits of the electrons and of the charged particles oscillate gyromagnetically.

According to the invention, the means 9, 10 for generating the first uniform electrical field E1 comprises:
a first cylinder 9 coaxial to the longitudinal axis X-X′, made of an electrically conductive material, delimiting the volume of the treatment chamber 40, the upstream end of this first cylinder 9 is fixed to the first perforated plate 2a and the downstream end of the first cylinder 9 is fixed to the third perforated wall 32, this first cylinder 9 being powered by the first alternating voltage V6,
a second cylinder 10 made of an electrically conductive material, the longitudinal axis of which is colinear to the longitudinal axis X-X′, disposed concentrically inside the first cylinder 9, the upstream end of the second cylinder 10 is fixed to the second perforated plate 2b, its downstream end is a free end with teeth 33, and the second cylinder 10 has a plurality of circumferential drilled holes 17; 18a; 18b through which the gas ionized by the plasma circulates, this second cylinder 10 being powered by the second alternating voltage V7, the first alternating voltage V6 and the second alternating voltage V7 having the same amplitude and the same frequency but being in phase opposition, the powering system of the first and second cylinders 9; 10 inducing a capacitive coupling.

Furthermore, the circumferential drilled holes 17; 18a; 18b of the second cylinder 10 comprise at least three circumferential series of circular perforations 18a; 18b from the downstream free end of this second cylinder 10, and a circumferential series of rectangular perforations 17 extending longitudinally along the axis X-X′ and disposed approximately toward the upstream end of the second cylinder 10.

According to the device of the invention, the means 4 for generating the first uniform magnetic field B1 comprises a solenoid-forming assembly 4 surrounding the first cylinder 9 and the means 5 for generating the second uniform magnetic field B2 comprises a second solenoid 5 disposed inside the second cylinder 10, the first and second solenoids, 4 and 5 respectively, being powered by a current I1 and these first and second magnetic fields B1, B2 inducing an inductive coupling in the treatment chamber 40.

Preferably, the means 6, 7 for emitting electromagnetic signals in the treatment chamber 40 comprises:
a central rod 6 made of an electrically conductive material extending longitudinally inside the treatment chamber 40 and presenting a tapered end, this central rod 6 is fixed to the first plate 2a, perpendicularly and approximately in its center, and it is surrounded by the second solenoid 5 over at least a part of its length, this central rod 6 being powered by the first alternating voltage V6;
a plurality of peripheral rods 7, made of an electrically conductive material, extending longitudinally inside the treatment chamber 40, presenting a tapered end, these peripheral rods 7 are fixed to the second perforated plate 2b perpendicularly to the latter, and are disposed concentrically on a circle of radius between the radius of the first cylinder 9 and the radius of the second cylinder 10, these peripheral rods 7 being powered by the second alternating voltage V7.

Furthermore, the means 12, 13 for generating the second electrical field E2 by the application of a third alternating voltage V3 comprises:
a plurality of large radial partitions 12 made of an electrically conductive material, extending longitudinally in the treatment chamber 40 such that their longitudinal free edges are parallel to the axis X-X′, these large radial partitions 12 are fixed, on their longitudinal part, to the internal surface of the first cylinder 9 and they are fixed on their upstream transverse part to the first perforated plate 2a, the transverse width of these large partitions 12 is less than the distance between the first cylinder 9 and the second cylinder 10, the first alternating voltage V6 being applied to the diametrically opposite large partitions 12;
a plurality of small radial partitions 13 made of an electrically conductive material, extending longitudinally in the treatment chamber 40 such that their longitudinal free edges are parallel to the axis X-X′, these small radial partitions 13 are fixed, on their longitudinal part, to the internal surface of the first cylinder 9 and they are fixed on their upstream transverse part to the first perforated plate 2a, the width of these small partitions 13 is less than the width of the large partitions 12, the small partitions are diametrically opposite and they include at least three series of circular perforations 132 from their downstream transverse free edge, and the first alternating voltage V6 is applied to the small partitions 13.

Preferably, the powering system 14 comprises:
an electrical power supply means 23 for this powering system 14 delivering an alternating voltage V4,
a means 35 for transforming the alternating voltage V4 from the input source 23 into an intermediate alternating voltage V5,
a means 36 for varying the frequency of the intermediate alternating voltage V5, and
a means 28 for transforming this intermediate alternating voltage V5 into the first and second output alternating voltages, V6 and V7 respectively, and into the output current I1.

According to the invention, the electrical power supply means 23 is a mains input source which supplies a mains voltage V4 of approximately 220 V at a frequency of approximately 50 hertz.

Furthermore, the value of the intermediate alternating voltage V5 is between approximately 10 and 50 volts.

The value of the intermediate alternating voltage V5 can take approximate values of 10, 24 or 50 volts.

Also, the value of the first and second alternating voltages V6; V7 is between 1 and 30 kilovolts at a frequency of between 5 hertz and 10 kilohertz for a power of between 1 and 300 watts.

The means 28 for transforming the intermediate alternating voltage V5 into the first and second alternating voltages V6; V7 is a transformer 28, the impedance of which is adapted automatically and with no loss of power to the varying impedance of the device.

Preferably, the core of the transformer 28 is based on ferrite and rare earth elements and the value of the current (I1) is between 1 microAmp and 0.1 Amp.

Advantageously, the value of the first and second alternating voltages V6; V7 is approximately 15 kilovolts for an output power of approximately 100 watts.

Also, the value of the output alternating voltage V6; V7 can be approximately 5 kilovolts for an output power of approximately 30 watts.

According to the invention, the confinement chamber 1 can comprise a second treatment chamber 41 in the extension of the first treatment chamber 40, in which the first cylinder 9 is prolonged by a first truncated conical nacelle 42 made of an electrically conductive material, converging toward the third perforated wall 32 which separates the two treatment chambers 40, 41; the perforated wall 32 is sandwiched between a third perforated transverse plate 43 made of an electrically conductive material integral to the first nacelle 42 and a fourth perforated transverse plate 44 made of an electrically conductive material; the second treatment chamber 41 is formed by a second truncated conical nacelle 47 integral to the fourth plate 44, converging toward the upstream chamber and integral at its downstream end to a third cylinder 48 made of an electrically conductive material, integral, via its downstream end, to a fifth perforated transverse plate 50 made of an electrically conductive material; a fourth perforated wall 51 made of an electrically insulating material is fixed to the downstream side of the fifth plate 50; a sixth perforated transverse plate 59 made of an electrically conductive material is fixed to the downstream side of the fourth wall 51; and a fifth perforated transverse wall 60 made of an electrically insulating material is fixed to the downstream side of the sixth plate 59; and the second treatment chamber 41 also comprises a fourth cylinder 52 made of an electrically conductive material fixed to the sixth perforated plate 59 and including a series of at least three transverse rows of circumferential drilled holes 53 at its upstream free end and teeth 54 extending axially from its free end; and a fifth cylinder 55 of diameter less than that of the cylinder 52 and longer than the length of the cylinder 52, the fifth cylinder 55 being fixed to the fifth plate 50 and including a series of at least three transverse rows of circumferential drilled holes 56 at its upstream free end and teeth 57 extending axially from its free end, and the device also comprises a rod 45 with tapered free end made of an electrically conductive material fixed to the plate 44 and projecting into the upstream chamber 40 by passing through the wall 32 and the plate 43 in an electrically insulated manner; spikes 49 made of an electrically conductive material disposed concentrically on the fourth plate 44 and projecting into the downstream chamber 41; and the solenoid-forming assembly 4 comprising three solenoids 4a, 4b, 4c attached and disposed coaxially around the upstream and downstream chambers 40, 41, the number of windings of the second solenoid 4b being greater than the number of windings of the first and third solenoids 4a, 4c.

In this device, the first alternating voltage V6 is applied to the plate 2a and to the plate 59, and the second alternating voltage V7 is applied to the plate 2b and to the plate 50.

Furthermore, the gaseous medium comprises a stream of ambient air or of any other gaseous medium at ambient temperature and atmospheric pressure, and this gaseous medium is charged with any combination of inert particles, nonbiological organic particles, contaminant inorganic particles, biological particles such as bacteria, bacterial spores, fungi, fungal spores and/or viruses, and in which these particles are destroyed or transformed during their passage through the treatment chamber 40 before leaving the treatment chamber 40 through the third perforated wall 32.

Furthermore, the device of the invention comprises at least one manual or automatic probing device, this probing device being used to provide information concerning the presence of the various types of contaminants, this information being transmitted manually or automatically to a control device coupled to the powering system 14, this control device being used to modulate the alternating voltage V6; V7 and the current I1 according to the level of contamination at the device inlet.

The invention will be better understood and other objects, advantages and features of the latter will become more clearly apparent from reading the description that follows which is given in light of the appended drawings which represent nonlimiting examples of embodiments of the invention, and in which:

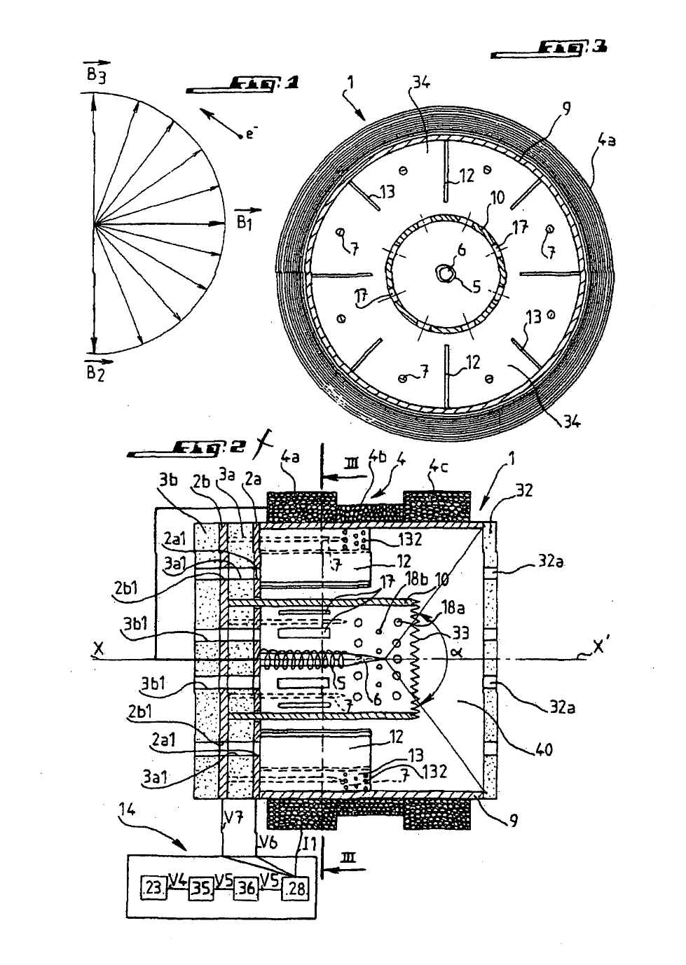

FIG. 1 is a diagram representing the general concept of the invention;

FIG. 2 represents a longitudinal cross-sectional view of the plasma-generator-forming device according to a first embodiment of the invention;

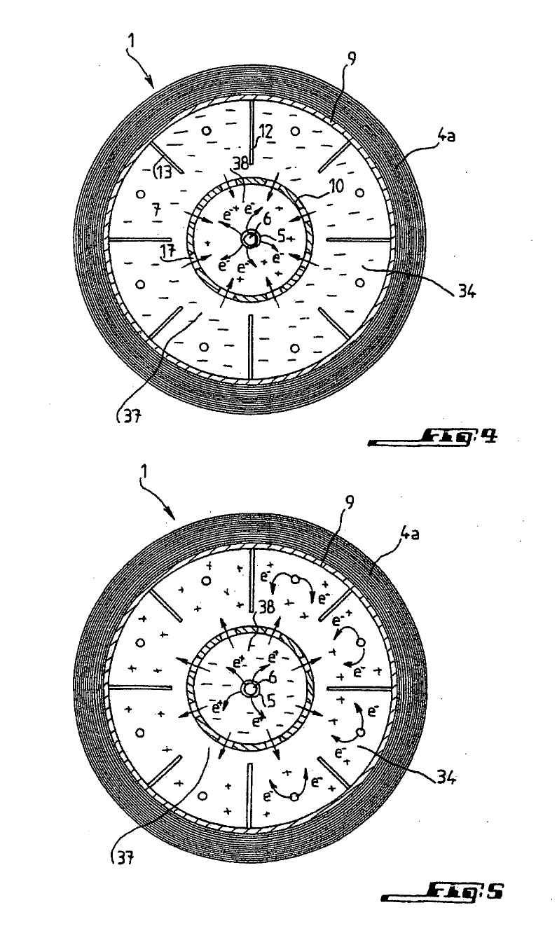

FIG. 3 is a cross-sectional view through the axis III-III of FIG. 2;

FIG. 4 is a cross-sectional view through the axis III-III of FIG. 2 showing the distribution of charges according to a first electronic state;

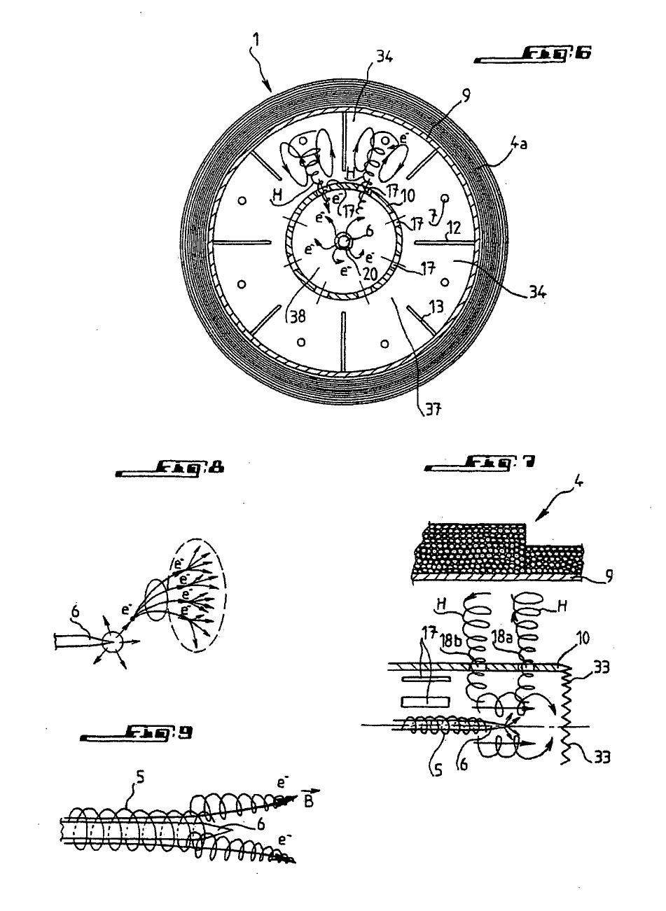

FIG. 5 is a cross-sectional view through the axis III-III of FIG. 2 showing, in particular, the distribution of charges according to a second electronic state;

FIG. 6 is a cross-sectional view through the axis III-III of FIG. 2 showing the gyromagnetic path of the electrons in the device of the invention;

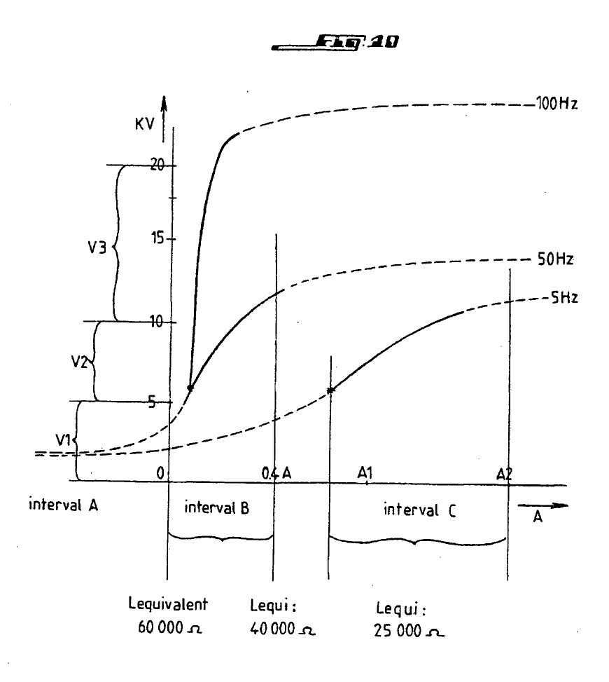

FIG. 7 is a longitudinal cross-sectional view of a part of the device of the invention showing the gyromagnetic path of the electrons;

FIG. 8 represents the electron avalanche phenomena in a part of the device of the invention;

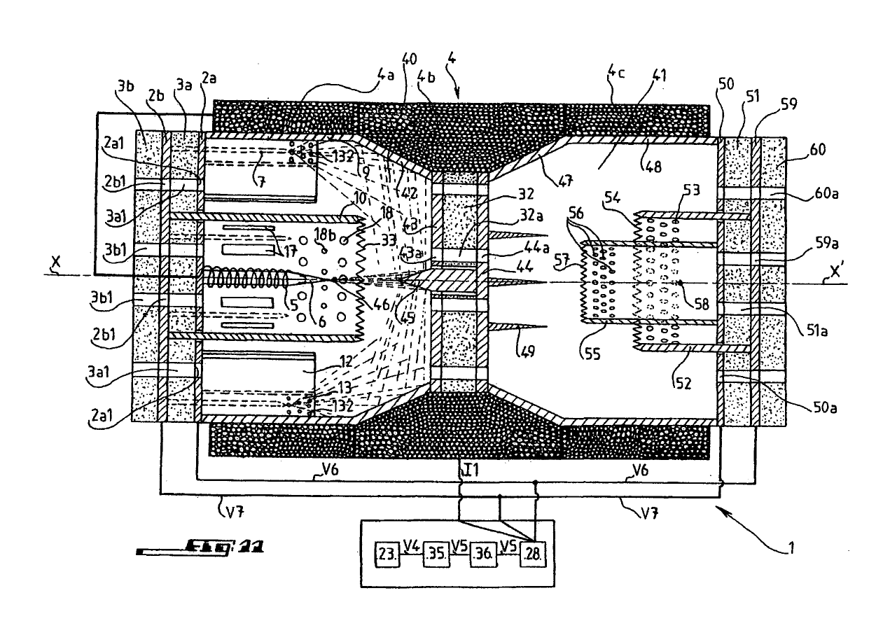

FIG. 9 represents the gyromagnetic path of the electrons in a part of the device of the invention;

FIG. 10 represents the high voltage electrical power supply curves with the main frequency modulations used to electrically power the device of the invention;

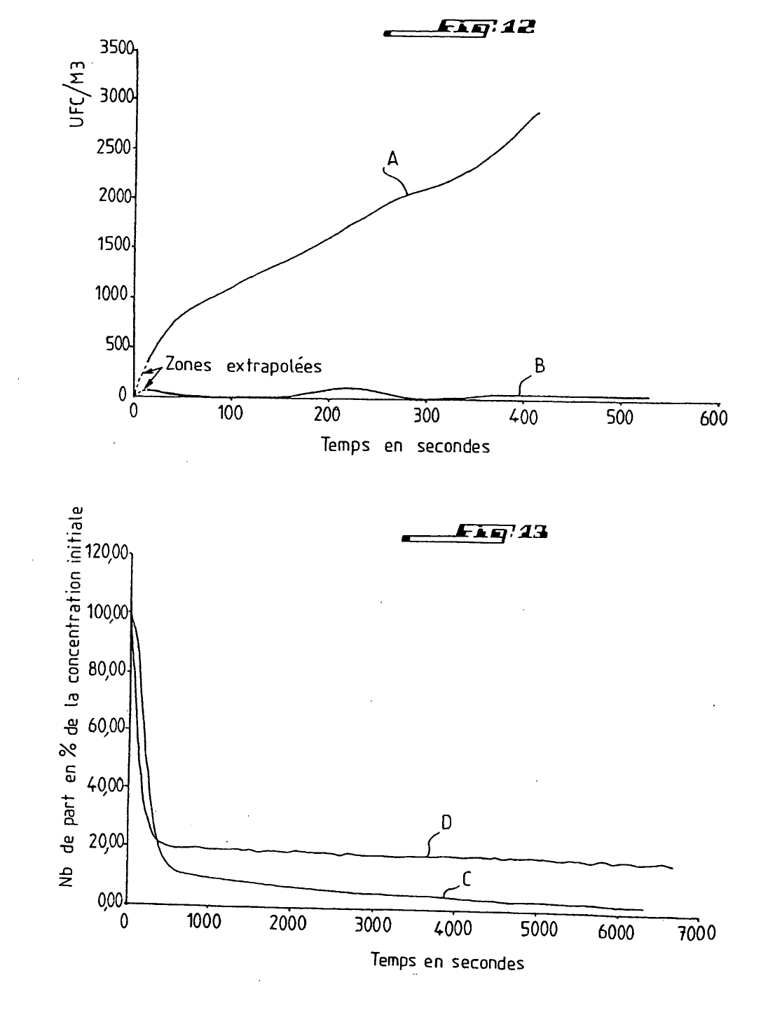

FIG. 11 is a longitudinal cross-sectional view of the plasma-generator-forming device according to a second embodiment of the invention;

FIG. 12 is a curve representing the prevention of contamination as the gas stream passes through the device of the invention; and

FIG. 13 is a curve representing the particular decontamination profiles as the gas stream passes through the device of the invention.

The ECR systems used in the prior art employ the interaction between a varying electrical field and a static magnetic field. The method according to the invention differs from the conventional methods that use electron cyclotron resonance since the general concept of the invention associates a number of scientific bases comprising, generation of the plasma in a high frequency electromagnetic field, generation of the plasma by capacitive and inductive couplings and magnetic resonance involving an active proportion of diverse multifrequency waves for greatly agitating the plasma. The association of these scientific bases results in the formation, among other things, of an electromagnetic field and a nonstanding magnetic field. As represented in FIG. 1, an electron is subjected to an electromagnetic field EM1 near to a varying magnetic field, which constitutes the general concept of the invention.

Referring to FIGS. 2 and 3, the device of the invention according to a first embodiment comprises a confinement chamber 1. In this chamber 1, a longitudinal axis X-X′ is defined. The confinement chamber 1 includes at its upstream end a first perforated plate 2a made of an electrically conductive material, this first plate 2a having circular perforations 21.

A first perforated wall 3a made of an electrically insulating material and opaque to the electromagnetic signals is fixed coaxially to the upstream side of the first perforated plate 2a. This first perforated wall 3a also has circular perforations 3a1.

A second perforated plate 2b made of an electrically conductive material is fixed coaxially to the upstream side of the first perforated wall 3a. This second perforated plate 2b also has circular perforations 2b1.

A second perforated wall 3b made of an electrically insulating material and opaque to the electromagnetic signals is fixed coaxially to the upstream side of the second perforated plate 2b. This second wall 3b has circular perforations 3b1.

Preferably, the circular perforations of the first and second perforated plates 2; 2a and of the first and second perforated walls 3; 3a correspond coaxially so as to provide the inlet for the gas stream to be treated into the confinement chamber 1.

The device also comprises, at its downstream end, a third perforated wall 32 made of an electrically insulating material and opaque to the electromagnetic signals and axially spaced from the first perforated plate 2a. This third wall has circular perforations 32a through which the gas stream leaves the chamber 1.

According to the invention, the device comprises a first cylinder 9 made of an electrically conductive material, preferably metallic, which, with the wall 32 and the plate 2a, delimits the volume of the confinement chamber 1. The upstream end of the first cylinder 9 is fixed to the first perforated plate 2a and its downstream end is fixed to the third wall 32 and the longitudinal axis of the first cylinder 9 coincides with the axis X-X′.

A second cylinder 10, made of an electrically conductive material, preferably metallic, delimiting an internal volume less than the internal volume of the first cylinder 9, is disposed coaxially at this first cylinder 9 in the confinement chamber 1. The upstream end of the second cylinder 10 is fixed to the second perforated plate 2b, and, preferably, centered on the latter. For this, the second cylinder 10 passes through the first perforated plate 2a and the first perforated wall 3a in an electrically insulated manner. The downstream end of this second cylinder 10 is a free end.

Preferably, the diameter of the first cylinder 9 is between 10 and 50 cm and the diameter of the second cylinder 10 is between 30 and 50% of the diameter of the first cylinder 9. The length, along the longitudinal axis X-X′, of the first cylinder 9 is between 5 and 20 cm and the length, along this axis, of the second cylinder 10 is between 30 and 50% of the length of the first cylinder 9.

The second cylinder 10 includes, at its downstream free end, teeth 33 extending longitudinally and presenting a length between 0.5 and 1.5 mm and a spacing between teeth of approximately 0.8 mm. These teeth 33 are used, in particular, to emit electromagnetic energy for generating free electrons when the second cylinder 10 is powered at high alternating voltage.

Furthermore, the second cylinder 10 includes, from its downstream free end and approximately as far as halfway along its length, at least three circumferential series of circular perforations 18a and 18b, axially spaced. Preferably, the series of circular perforations 18a and 18b comprise alternating circumferential series of large circular perforations 18a of a diameter of approximately 2 mm and a circumferential series of small circular perforations 18b of a diameter of approximately 1 mm. Preferably, the large and small circular perforations 18a; 18b are staggered relative to each other.

Furthermore, the second cylinder 10 includes a circumferential series of rectangular perforations 17 located toward the upstream end of the second cylinder 10. These rectangular perforations 17 extend longitudinally, approximately, from the upstream end of the second cylinder 10 as far, approximately, as halfway along the length of the cylinder 10.

The rectangular perforations 17 and circular perforations 18a and 18b are used, in particular, to circulate the gaseous medium ionized by the plasma in the second cylinder 10 toward the exterior of this cylinder.

Preferably, the number of rectangular perforations 17 is 8 and the length of these rectangular perforations 17, along the axis X-X′, is between 10 and 30% of the length of the second cylinder 10. Furthermore, the arc along the circumference of the second cylinder 10 formed by the width of the rectangular perforations 17 is between 3 and 5.

The first cylinder 9 is surrounded by a solenoid-forming assembly 4 made up of three solenoids 4a, 4b, 4c attached and disposed coaxially relative to the axis X-X′. The number of windings per unit of length along X-X′ of the solenoids 4a and 4c is greater than the number of windings per unit of length along X-X′ of the solenoid 4b. This means that the value of the magnetic fields B1a and B1c induced by the application of a current to the solenoids 4a and 4c is greater than the value of the magnetic field B1b induced by the application of the same current to the solenoid 4b. Furthermore, the magnetic fields B1a and B1c are used to contain the flow of charged particles in the chamber 1.

The device according to the invention also comprises a plurality of large radial partitions 12, diametrically opposite and made of an electrically conductive material, preferably metallic. These large partitions 12 extend longitudinally in the chamber 1 such that their longitudinal free edges are parallel to the axis X-X′. These large partitions 12 are fixed, on their longitudinal part, to the internal surface of the first cylinder 9 and they are fixed, on their upstream transverse part, to the first perforated plate 2a. The length of the large radial partitions 12 is less than the length of the first cylinder 9 and their width is less than the distance between the first cylinder 9 and the second cylinder 10. In other words, the radial partitions 12 concentrically surround the second cylinder 10 without being in contact with it.

The device according to the invention also comprises a plurality of small radial partitions 13, diametrically opposite and made of an electrically conductive material, preferably metallic. These small partitions 13 extend longitudinally in the chamber 1 such that their longitudinal free edges are parallel to the axis X-X′. These small partitions 13 are fixed, on their longitudinal part, to the internal surface of the first cylinder 9 and they are fixed, on their upstream transverse part, to the first perforated plate 2a. The length of the small partitions 13 is equal to the length of the large partitions 12, whereas their width is less than the width of the large partitions 12. These small partitions 13 include, from their downstream transverse free end, at least three series of circular perforations 132 disposed parallel to this transverse edge.

As illustrated in FIG. 3, a small partition 13 is disposed between two successive large partitions 12. Preferably, the device includes four large partitions 12 and four small partitions 13. The alternation of a large partition 12 and a small partition 13 results in the presence of inter-partition cavities 34.

Preferably, the length of the large partitions 12 and of the small partitions 13 is between 30 and 60% of the length of the first cylinder 9, the width of the large partitions 12 is between 10 and 30% of the radius of the first cylinder 9 and the width of the small partitions 13 is between 5 and 20% of the radius of the first cylinder 9.

The device also comprises a plurality of peripheral rods 7 made of an electrically conductive material, preferably metallic, extending longitudinally inside the chamber and including a tapered end. These peripheral rods 7 are fixed to the second perforated plate 2b, passing through the first perforated plate 2a and the first perforated wall 3a in an electrically insulated manner and they are disposed concentrically on a circle of radius between the radius of the first cylinder 9 and the radius of the second cylinder 10. As illustrated in FIG. 3, the peripheral rods 7 are, preferably, disposed in the inter-partition spaces 34 and the number of peripheral rods 7 is therefore equal to the number of inter-partition spaces 34.

Furthermore, the device also includes a central rod 6 made of an electrically conductive material, preferably metallic, extending longitudinally in the confinement chamber 1 and presenting a tapered end, this central rod 6 being fixed to the first plate 2a, perpendicularly to the latter and approximately in its center. Preferably, the tapered end of the central rod 6 has a length of 10 mm. The length of the central rod 6 is less than the length of the second cylinder 10. The central rod 6 is surrounded over at least a part of its length by a second solenoid 5, the longitudinal axis of the second solenoid 5 being colinear to the axis X-X′.

According to the invention, the field lines formed by the magnetic field B1 pass through a first closed curve located in a plane perpendicular to the longitudinal axis X-X′ and centered on this axis and the field lines of the magnetic field B2 pass through a second closed curve located in the same plane as the plane containing the first closed curve and the second closed curve is located inside the first closed curve since the volume in which the magnetic field B1 is confined is greater than the volume in which the magnetic field B2 is confined, this resulting from the geometrical configuration of the solenoid-forming assembly 4 and the solenoid 5.

Preferably, the angle formed by a first segment running from the tapered end of the central rod 6 to any first point inside the first cylinder 9 located downstream relative to the tapered end of the central rod 6 and by a second segment running from the tapered end of the central rod 6 to any second point inside the first cylinder 9 located downstream relative to the tapered end of the central rod 6 and opposite to the first point is between approximately 80 and 120°. FIG. 2 represents the maximum angle α that the two segments can make from the tapered end of the central rod 6 to the downstream edge of the first cylinder 9.

The device is electrically powered by a powering system 14.

This powering system 14 is itself electrically powered by an input source 23 delivering an alternating voltage V4. Preferably, this input source 23 delivers an alternating voltage V4 from the mains of approximately 220 V at a frequency of approximately 50 Hz.

This powering system 14 includes a voltage step-down device 35 for reducing the input alternating voltage V4 to an intermediate voltage V5 and this intermediate voltage V5 can preferably take values of 10, 24 or 50 volts for a frequency of approximately 50 hertz.

The powering system 14 also comprises a frequency generator 36 formed by an RLC circuit providing electronic amplification to obtain the power supply frequency of the device of the invention from the frequency of the intermediate alternating voltage V5. The frequencies generated by this frequency generator 36 are between 50 hertz and 10 kilohertz for a power of between 1 and 300 watts.

Finally, the powering system 14 comprises a transformer 28 used to obtain, at the frequency generated by the frequency generator 36, two output alternating voltages V6; V7. The values of the output alternating voltages V6; V7 are between 1 and 30 kV for a frequency of between 50 hertz and 10 kilohertz.

As an example, the powering system 14 can generate two output alternating voltages V6 and V7 of approximately 15 kV for a power of approximately 100 watts or two output alternating voltages V6 and V7 of approximately 5 kV for a power of approximately 30 watts.

The varying impedance of the device of the invention results from the varying electromagnetic fields and from the spatial distributions of the charged particles generated inside the device. The core of the transformer 28 is based on ferrite and rare earth elements, so the impedance of the transformer 28 is adapted automatically and with no loss of power to the varying impedance of the device of the invention.

The powering system 14 is also used to generate an alternating current I1 which powers, in series, the solenoid-forming assembly 4 and the second solenoid 5, the value of the current I1 being between 1 microAmp and 0.1 Amp.

The powering system 14 as described previously will have an overall equivalent impedance L including the impedances of the components associated with the elements of the device of the invention and the varying electromagnetic fields and the spatial distributions of the charged particles generated in the device. This equivalent impedance will give rise to damped resonance harmonic oscillations for the specific combination (i) of the current I1 which powers the solenoids 4a, 4b, 4c and 5, (ii) of the maximum amplitude of the alternating voltage applied, in particular, to the first cylinder 9, to the second cylinder 10, to the large partitions 12 and to the small partitions 13, and (iii) of the frequency of the alternating voltage which powers the first cylinder 9, the second cylinder 10, the large partitions 12, the small partitions 13 as well as the peripheral rods 7 and the central rod 6. It is difficult and complicated to calculate these specific combinations which give rise to damped resonance harmonic oscillations by mathematical equations or computer simulations. These specific combinations which give rise to damped resonance harmonic oscillations, where “resonance combinations”, can be determined experimentally.

When the diameter of the first cylinder 9 is 13 cm and the current delivered in the solenoids 4a, 4b, 4c and 5 is 0.1 Amp, the resonance combinations are (i) 1 kV, 350 hertz, (ii) 1.5 kV, 500 hertz and (iii) 2 kV, 650 hertz.

Preferably, the first and second output alternating voltages V6; V7 have identical voltage and frequency values but they are in phase opposition.

According to the invention, the first output alternating voltage V6 powers the first perforated plate 2a. Consequently, this first output alternating voltage V6 powers the first cylinder 9, the large partitions 12 and the small partitions 13, as well as the central rod 6.

The second output alternating voltage V7 powers the second perforated plate 2b. Consequently, this second output alternating voltage V7 powers the second cylinder 10 and the peripheral rods 7.

The application of the current I1 to the solenoid-forming assembly 4 causes the formation of the magnetic field B1, the field vector of which is colinear to the axis X-X′. The application of the current I1 in the second solenoid 5 surrounding the central rod 6 results in the formation of a second magnetic field B2, the field vector of which is also colinear to the longitudinal axis X-X′. The resultant of these magnetic fields B1 and B2 is a magnetic field B, the field vector of which is naturally colinear to the axis X-X′. The inductive coupling is produced by the creation of an internal and concentric volume formed by the solenoids 4a and 4c with strong external flux and the smaller solenoid 4b in the central periphery. The presence of the uniform magnetic field B located in the first and second cylinders 9; 10 and in the inter-partition spaces 34 leads, as will be detailed later, to (i) a density of free electrons and an ion flux at the central rod 6 and the peripheral rods 7 greater than those resulting from the conventional crown discharge techniques, and (ii) a substantially uniform magnetic field B supporting a large plasmatic volume at the resonance frequency of the ECR system resulting in an increased coupling of the electromagnetic energy originating from the input electrical energy and the electromechanical energy through the plasma. These attributes are important for achieving the objectives of the present invention.

Preferably, the value of the magnetic field B1 resulting from the application of the current I1 in the solenoid 4, on the longitudinal axis X-X′ is between 10 and 100 milliteslas and the impedance is between 50 and 100 ohms. The solenoids 4a and 4b produce, when a current I1 of approximately 0.1 Amp is applied to them, a magnetic field, the value of which is approximately 200 milliteslas in the vicinity of the solenoid 4b and 10 milliteslas in the vicinity of the axis X-X′. The solenoid 4b produces, when the current I1 of approximately 0.1 Amp is applied to it, a magnetic field, the value of which is approximately 100 milliteslas in the vicinity of the solenoids 4a and 4c and 5 milliteslas in the vicinity of the axis X-X′.

The solenoid 5 creates, according to the invention, a magnetic field, the field vector of which is colinear with the axis X-X′ and the value of which is between 10 and 100 milliteslas and an impedance between 4 and 10 ohms.

The frequency of the high alternating voltages V6 and V7 applied, in particular, respectively to the first and second cylinders 9, 10 is roughly equal to the resonance frequency of the ECR system. The effect of applying these alternating current high voltages V6 and V7 at this frequency in the presence of the magnetic field B is to generate a population of free electrons which are subject to a centripetal acceleration in which the plane of the orbit created by this centripetal acceleration is roughly perpendicular to the vector representing the magnetic field B. Furthermore, each free electron which has a velocity directional component roughly parallel to the vector representing the magnetic field B will have a helical path in the direction of the vector representing the magnetic field B. As long as an electron is subject to the centripetal acceleration of this ECR system and the resonance alternating voltage is applied to the first and second cylinders 9, 10, the velocity and thus the kinetic energy of the electron will increase. The capacitive coupling resulting from the application of the output voltages V6 and V7 to the first and second cylinders 9, 10 is necessary to achieve the objectives of the invention.

Reference is now made to FIG. 4 which shows the effect of applying the first alternating voltage V6 to the first cylinder 9 and of applying the second alternating voltage V7 to the second cylinder 10, which generates an electrical field E1, the field vector of which is roughly perpendicular to the axis X-X′, these two output alternating voltages V6 and V7 being in phase opposition. FIG. 4 thus represents the effect of the capacitive coupling between the first and second cylinders 9, 10 in a half-cycle in which the first cylinder 9 is powered positively relative to the second cylinder 10. In this electrical configuration, a negative space charge is developed in the first space 37 between the first and second cylinders 9, 10, and a positive space charge is developed in the second space 38 between the central rod and the second cylinder 10. The rectangular perforations 17 of the second cylinder 10 lead to a concentric transfer of the charged particles, which generates a spatial charge flux from the first space 37 to the second space 38. Furthermore, the central electrode 6 is powered by the first alternating voltage V6, that is, in phase opposition relative to the second cylinder 10. This electrical configuration involves the emission of an electromagnetic signal EM1 created by the central electrode 6 surrounded by the second solenoid 5 and the generation of free electrons along the entire central electrode 6.

FIG. 5 represents the effect of the capacitive coupling between the first and second cylinders 9, 10 in the case where the first cylinder 9 is powered negatively relative to the second cylinder 10. In this electrical configuration, a positive space charge is developed in the first space 37 and a negative space charge is developed in the second space 38. The rectangular perforations 17 of the second cylinder 10 lead to a concentric transfer of the charged particles, which generate a spatial charge flux from the second space 38 to the first space 37. This electrical configuration involves the emission of an electromagnetic signal EM2 at the peripheral rods 7 and the generation of free electrons all along these peripheral electrodes 7 as well as the generation of positrons on the central rod 6.

The first alternating voltage V6 is applied to the large partitions 12 and to the small partitions 13. Each pair of consecutive partitions comprising by a large partition 12 and a small partition 13 can therefore be likened to a capacitor, the operation of which is known from the prior art. The first alternating voltage V6 applied to each pair of large and small partitions 12, 13 causes the formation of an electrical field E2 in the inter-partition space 34, the vector of this electrical field E2 changing direction in step with the half-cycles of the voltage applied and this vector not being parallel to the vector representing the first electrical field E1. By applying Maxwell's law concerning the induction of a capacitor, these alternating electrical fields induce, as represented in FIG. 6, in each inter-partition space 34, a circular magnetic field located in a plane approximately parallel to the large and small partitions 12, 13, such that the vector of this magnetic field is tangential at any point to the circular path of this field in the direction defined by the three-finger rule, well known from the prior art, in a phase half-cycle. In this same phase half-cycle, the magnetic field induced, according to the same theory, in an adjacent inter-partition space 34, will have the same characteristics as defined previously but the direction of its circular path will be opposite as represented in FIG. 6. At the change of half-cycle of the power supply voltage of the large and small partitions 12, 13, the direction of rotation of each magnetic field in each inter-partition space 34 will be reversed. Furthermore, in a half-cycle, the value of the magnetic field will vary equally according to the value of the alternating voltage.

Furthermore, the arc of the angle formed by a vector representing the first electrical field E1 and by each vector representing the second electrical field E2 is between 60 and 120°.

Reference is now made to FIG. 7 in conjunction with FIG. 6. At any point located in the first space 37 and the second space 38, there is a vector representing a gyromagnetic field resulting from the addition of the vector representing the magnetic field B and the vector representing the varying electrical field E2 induced by the application of the first alternating voltage V6 to the large and small partitions 12, 13, as explained previously. The vector representing the gyromagnetic field culminates in a multiplicity of swirling free electrons having the capacity to cut and fragment the particles forming the gas stream. The combination between the vector representing the magnetic field B and the vector representing the gyromagnetic field characterizes the device according to the invention.

Preferably, the frequency of the first alternating voltage V6 applied to the large and small partitions 12, 13 is chosen such that the free electrons generated along the peripheral rods 7 are subjected to the electron cyclotron resonance, this resonance being generated by the combination of the alternating voltage and the vector representing the gyromagnetic field as well as by the presence of the electrical field E1 induced by the application of the first and second alternating voltages V6, V7 respectively to the first and second cylinders 9, 10, the result of which is a movement of the free electrons along a helical path H about the vector representing the gyromagnetic field, these electrons passing through the perforations 17 (FIG. 6) and 18a and 18b (FIG. 7) of the second cylinder 10.

The velocity of the free electrons caused by the multipolar electron cyclotron resonance is sufficiently great for a blue light characteristic of the Cerenkov effect, well known from the prior art, to be observable at the perforations 17, 18a and 18b of the second cylinder 10. Emission spectroscopy analysis of this light suggests that the energy revealed by the presence of this light is due to the energy emitted by the hadronic pulsations in the atom population of the plasma. In particular, this suggests that the results obtained by the present invention can be used as tools in the fields of nuclear physics, nuclear energy, quantum chromodynamics and string theory.

It can be demonstrated that the resultant electromagnetic and electromechanical energy fluxes and the electron cyclotron resonances have an amplitude and a frequency that are sufficiently high, according to the physical dimensions of the cavities of the device of the invention, for the average free travel of the electrons to be smaller than the dimensions of these cavities. The cavities are the spaces delimited by the different elements of the device in the confinement chamber 1.

FIG. 8 represents the electron avalanches occurring on the peripheral rods 7 and the central rod 6. On applying a high alternating voltage to these rods at the tapered ends, the electrons acquire sufficient energy to ionize the molecules of the gas and trigger the electron avalanche mechanisms characterized by an exponential production of electrons. The central rod 6 and the peripheral rods 7 emit an electromagnetic signal, respectively EM1 and EM2, around their ends. This signal or field ionizes the atom populations of the gaseous medium around the rods and creates a plurality of free electrons which are also subject to the additional electrical field resulting from the application of the first and second alternating voltages V6, V7 to the first and second cylinders 9, 10.

FIG. 9 represents the cyclotron path of the electrons around the tapered end of the central rod 6 under the effect of the magnetic field B2 resulting from application of the current I1 in the second solenoid 5. In this case, the presence of the magnetic field B2 with the additional effect of the electrical field B1 increases the electron density around the tapered end of the central rod 6, the effect of which is to create, in this space, dense avalanches of free electrons which create an extension of the tapered part of the central rod 6.

Reference is now made to FIG. 10 which represents the alternating current electrical power supply curves at very high voltage with the main frequency modulations used to power the device according to the invention. To define the desired effects, an equivalent impedance Lequivalent is defined, corresponding to the equivalent impedance of the electron multiplication space and the equivalent impedance of the ion drift space. This equivalent impedance has been tested at three values of 60 000, 40 000 and 25 000 ohms. The voltages correspond to 5 to 9 kilovolts for the first level, 6 to 12 kilovolts for the second level and 10 to 20/30 kilovolts for the third level. At a frequency of 5 hertz, the optimum use for the electron multiplication space is located between 2 and 6 kilovolts, the use of low frequencies, below 6 hertz, favoring the standing wave planes. For a frequency of 50 hertz, the recommended use will be a voltage of 5 to 12 kilovolts to favor the ion drift space, the electrical consumption being average in this case. For a frequency of 100 hertz, the intensity absorbed is low and constant up to a voltage value of around 12 to 15 kilovolts, the electron multiplication and ion drift spaces being, in this case, totally coincident and uniform.

FIG. 11 represents a second embodiment of the device according to the invention. This device has two treatment chambers, one upstream 40 and one downstream 41, according to the direction of flow of the gas stream. The downstream chamber 41 is disposed in axial extension of the upstream chamber 40. The elements of the upstream treatment chamber 40 are identical to the elements contained in the confinement chamber 1 corresponding to the first embodiment of the invention apart, in particular, from the addition, in the extension of the first cylinder 9 along the direction of flow of the gas stream and integral to the latter, of a first truncated conical nacelle 42 converging toward the downstream chamber. This first truncated conical nacelle 42, made of an electrically conductive material, preferably metallic, is used to reflect the hydronic jets resulting from the operation of the device according to the invention.

The third perforated wall 32 is sandwiched between a third perforated plate 43 made of an electrically conductive material, and a fourth perforated plate 44, made of an electrically conductive material, preferably metallic. The third perforated plate 43 is integral to the downstream end of the truncated conical nacelle 42. The assembly formed by the transverse perforated plates 43 and 44 and the wall 32 allow the gas stream to pass from the upstream chamber 40 to the downstream chamber 41 through the perforations 43a, 44a of the perforated plates 43 and 44 and through the perforations 32a of the wall 32 in alignment with each other. Furthermore, this assembly also serves to accelerate electrons as they pass from the upstream chamber 40 to the downstream chamber 41 and thus forms an electron accelerator based on the differences in potentials applied respectively to the plates 43 and 44 as will be seen later.

Furthermore, a rod 45 made of an electrically conductive material is fixed to the fourth perforated plate 44 coaxially to the axis X-X′ and has its free tapered end projecting into the upstream chamber 40 in line with the central rod 6. The rod 45 thus passes through the third perforated wall 32 and the third perforated plate 43 in a manner electrically insulated from the latter. The tapered end of the rod 45 is also used to reflect the hydronic jets.

In the upstream chamber 40, the center of electrical balance 46 is located approximately at the end of the central electrode 6. The center of electrical balance 46 and the end of the peripheral rods 7 are active centers of very high electron density with cyclotron pulsation at hybrid harmonics which are projected along the axis X-X′. The hydronic jets are reflected on the first truncated conical nacelle 42 and on the tapered end of the rod 45 and thus create combinations of reflected and incident plasmas which mainly help to increase the density of the plasma of the upstream chamber 40 to favor the electrical, electronic and electromagnetic resonances in this chamber.

The downstream chamber 41 is defined by a second truncated conical nacelle 47 made of an electrically conductive material, converging toward the upstream chamber 40 and fixed, at its larger diameter end to the fourth perforated plate 44, and by a third cylinder 48 made of an electrically conductive material, located in extension of the truncated conical nacelle 47, being coaxial to the axis X-X′. The third cylinder 48 is made of a single piece with the truncated conical nacelle 47. This second truncated conical nacelle 47 provides uniform high velocity diffusion of the plasmatic flux.

The fourth perforated plate 44 supports spikes 49 made of an electrically conductive material. The spikes 49 are fixed to the fourth perforated plate 44 concentrically to the longitudinal axis X-X′. The space charge confinement volumes at the ends of the spikes 49 create electron avalanches by cyclotron pulsation.

A fifth perforated plate 50, made of an electrically conductive material, is fixed transversally to the downstream end of the third cylinder 48 and is thus electrically linked to the latter. Furthermore, a fourth perforated wall 51 made of an electrically insulating material and opaque to the electromagnetic signals is fixed to the downstream side of the fifth perforated plate 50. A sixth perforated plate 59 made of an electrically conductive material is fixed to the downstream side of the fourth perforated wall 51 and a fifth perforated wall 60 made of an electrically insulating material and opaque to the electromagnetic signals is fixed to the downstream side of the sixth perforated plate 59.

The assembly formed by the fifth and sixth perforated plates 50, 59 and by the fourth and fifth perforated walls 51, 60 allow the treated gas stream to leave through their respective axially aligned perforations 50a, 51a, 59a, 60a.

The downstream chamber 41 comprises a fourth cylinder 52, made of an electrically conductive material, fixed to the sixth perforated plate 59 concentrically to the longitudinal axis X-X′ of the device and including a series of at least three transverse rows of drilled holes 53 made circumferentially through the lateral wall of this cylinder at its upstream free end. The fourth cylinder 52 also has teeth 54 projecting from its upstream circular free edge and extending axially. The free end of the fourth cylinder 52 is approximately located half way along the downstream chamber 41.

Preferably, the drilled holes 53 are circular and their diameter is between 1.5 and 2 mm and the teeth 54 have a height of approximately 2 mm, a width of between 1 and 1.5 mm and are spaced approximately 2 mm apart.

The downstream chamber 41 also comprises a fifth cylinder 55, made of an electrically conductive material, preferably metallic, fixed to the fifth perforated plate 50 concentrically to the longitudinal axis X-X′ of the device and disposed in the fourth cylinder 52. This fifth cylinder 55 has a diameter less than the diameter of the fourth cylinder 52 but is longer than the fourth cylinder 52. Furthermore, the fifth cylinder 55 has a series of at least three transverse rows of drilled holes 56 made circumferentially through the lateral wall of this cylinder. The fifth cylinder 55 also has teeth 57 projecting from its upstream circular free edge and extending axially.

Preferably, the drilled holes 56 are circular and their diameter is between 1.5 and 2 mm and the teeth 57 have a height of approximately 2 mm, a width of between 1 and 1.5 mm and are spaced approximately 2 mm apart.

The downstream chamber 41 has an electrical center of balance 58 which presents the same characteristics as the electrical center of balance 56 of the upstream chamber 40.

In this variant of the device, the solenoid-forming assembly 4 surrounds the upstream and downstream chambers 40, 41. This solenoid-forming assembly 4 is made up of three solenoids 4a, 4b and 4c attached and disposed coaxially relative to the axis X-X′. Unlike the device corresponding to the first embodiment of the invention, the number of windings of the solenoids 4a and 4c is less than the number of windings of the solenoid 4b. This means that the value of the magnetic fields B1a, B1c induced by the solenoids 4a and 4c is less than the value of the magnetic field B1b induced by the solenoid 4b.

FIG. 11 represents the powering system of the downstream chamber 41 that is also used to power the upstream chamber 40 as described previously. Thus, the fifth perforated plate 50 is powered by the second alternating voltage V7, which means that the assembly comprising the third cylinder 48, the truncated conical nacelle 47, the fourth perforated plate 44, the spikes 49 and the fifth cylinder 55 is in phase opposition relative to the assembly formed by the first cylinder 9, the truncated conical nacelle 42 and the third perforated plate 43.

The sixth perforated plate 59 is powered by the first alternating voltage V6, which means that the fourth cylinder 52 is in phase opposition relative to the assembly comprising the third cylinder 48, the truncated conical nacelle 47, the fourth perforated plate 44, the spikes 49 and the fifth cylinder 55.

The device according to the invention is passed through by a stream of air or any other gaseous medium containing any combination of inert particles, inorganic contaminant particles, nonbiological organic contaminant particles, biological particles such as bacteria, bacterial spores, fungi, fungal spores and viruses. This stream of air or this gaseous medium enters into the treatment chamber of the device of the invention, passing through the first and second perforated walls 3a and 3b and the first and second perforated plates 2a and 2b at ambient temperature and at atmospheric pressure.

Because of the high intensity of the electromagnetic and electromechanical energy of the free electrons, photons, radicals and ions created through the plasma-generator-forming device, the particles are destroyed or transformed as they travel through the device. The speed of destruction and transformation of the particles is very fast, this mainly being due to the velocities of the electrons and of the ions, to the intensities of the photon emissions originating from the unstable radicals as well as to the electron-electron, particle-electron and particle-ion collisions and to the volume of the plasma in which these velocities and these photon emissions are caused by the multipolar gyromagnetic electron cyclotron resonances according to the invention. The kinetic energy of the charged particles resulting from these velocities and from these photon emissions have the following effects: breakdown of the cell walls and/or of the proteins surrounding these biological particles and irreversible damage to the DNA and the RNA of these biological particles; fragmentation of the nonbiological organic particles and of the inorganic particles; segmentation, transformation or modification of the molecular structures and of the molecules.

FIG. 12 is a curve showing the sterilizing capabilities of the device according to the invention. The x-axis represents elapsed time in seconds and the y-axis represents the number of colonies of Bacillus stearothermophilus counted per unit of volume. The curve A which is a reference curve shows the increase in the number of bacteria over time. The curve B corresponds to the bacterial counts made at the output of the device according to the invention. It can be seen that the number of colonies of B.stearothermophilus is almost zero when the gas stream containing these bacteria has passed through the plasma-generator-forming device, the gas stream having been sterilized.

FIG. 13 is a curve showing the fragmentation of the particles that make up the gas stream passing through the device. The x-axis represents the elapsed time in seconds and the y-axis represents the number of particles as a percentage of the initial population. The curve C corresponds to the number of particles per unit of volume, the diameter of which is greater than 0.3 μm, and the curve D corresponds to the number of particles per unit of volume, the diameter of which is less than 0.3 μm. It can clearly be seen that the particles that make up the gas stream passing through the device are mostly fragmented into particles of a diameter less than 0.3 μm.

In the vicinity of the inlet of the device of the invention, at least one probing device, manually or automatically controlled, can be positioned, to test the gas stream before it enters into the device, for the presence and the quantity of different types of contaminants. The results of these tests can be transmitted electrically to a control device electrically coupled to the powering system 14. This control device can then control, according to the results of the tests, the output alternating voltages V6 and V7 and the current I1 to obtain different levels of operation of the device of the invention according to the level of contamination at the inlet of the device.

1-32. (canceled)

33. Method of operating a plasma-generating device for treatment of a gaseous medium, comprising the steps of:
(i) detecting a contamination level of said gaseous medium; and
(ii) according to said detected contamination level, modulating at least one electrical signal of said device.

34. Method according to claim 33, wherein the electrical signal is chosen from the group consisting of the alternating voltage being supplied to at least one pair of plasma electrodes, the current, or combinations thereof.

35. Method according to claim 33, comprising the following steps:
(a) the creation, in a confinement chamber, of a standing magnetic field (B) with a high degree of uniformity, the vector representing the standing magnetic field (B) being located along a longitudinal axis X-X′ passing through the confinement chamber, the value of this standing magnetic field (B) being variable,
(b) the creation of the plasma in the confinement chamber (1), in the presence of the standing magnetic field (B), by the emission in the gaseous medium of an electromagnetic signal (EM1, EM2), this emission being obtained by the application of at least one alternating voltage, the frequency and the amplitude of which are variable,
(c) the creation of at least one first variable electrical field (E1) in the plasma by the application of at least one alternating voltage, this alternating voltage having a variable amplitude and frequency and the vector representing the first electrical field (E1) being located on an axis perpendicular to the longitudinal axis X-X′, (d) the creation of at least one second electrical field (E2) in the plasma by the application of at least one alternating voltage, the amplitude and the frequency of this alternating voltage being approximately equal to the amplitude and the frequency of the alternating voltage generating the electrical field E1 and the vector representing the second electrical field (E2) being located on an axis not parallel to the axis on which the vector of the first electrical field (E1) is located,
(e) the application of electrical signals for controlling the value of the standing magnetic field (B), the frequency and the amplitude of the alternating voltages generating the electrical fields E1, E2 and the electromagnetic fields EM1, EM2, the application of these electrical signals being used to create (i) an electron cyclotron resonance (ECR) wherein the axis of the centripetal acceleration orbit of the electrons and of the other charged particles is parallel to the longitudinal axis X-X′ (ii) of the electron cyclotron resonances (ECR) wherein the axes of the centripetal acceleration orbits of the electrons and of the other charged particles oscillate gyromagnetically.

36. The method as claimed in claim 33, wherein the plasma generated is a cold plasma.

37. The method as claimed in claim 33, which is applied to the decontamination of the ambient air and of any other gaseous medium, by destroying and/or transforming the atoms and molecules that make up the contaminants present in the ambient air or in the gaseous medium, by the electromagnetic and electromechanical energy of the plasma.

38. The method as claimed in claim 37, wherein the contaminants are made up of one of the following types or a combination of the latter: microbic aerosols comprising pathogenic micro-organisms such as bacteria, spores, viral and retroviral particles, pathogenic proteinic agents such as prions; volatile and aromatic organic compounds, chlorofluorocarbons, various oxidizable and oxidizing elements such as oxygen, nitrogen and sulfur; ozone; and fibers and particles originating from dust and smoke.

39. The method as claimed in claim 37, wherein the air or any other contaminated gaseous medium is probed manually or automatically to determine the presence and/or the quantity per unit of volume of the various contaminants.

40. The method as claimed in claim 39, wherein the information or data concerning the presence or the quantity per unit of volume of contaminants in the ambient air or in the gaseous medium is used to modulate the electrical signals.

41. A plasma-generating device for treatment of a gaseous medium, comprising a control device and a powering system connected to said control device, and a detection device for detecting a level of contamination of said gaseous medium, wherein an electric signal of said plasma-generating device is modulated by said control device, according to the level of contamination detectable by said detection device.

42. Plasma-generating device according to claim 41, wherein the electrical signal is chosen from the group consisting of the alternating voltage being supplied to at least one pair of plasma electrodes, the current, or combinations thereof.

43. A plasma-generating device according to claim 41, wherein the plasma is of multipolar gyromagnetic electron cyclotron resonance (ECR) type, and which comprises:
(a) a gaseous medium confinement chamber (1) comprising at least one treatment chamber (40) which comprises at its upstream end a first perforated transverse plate (2a) made of an electrically conductive material, a first perforated wall (3a) made of an electrically insulating material and opaque to the electromagnetic signals, fixed to the upstream side of the first perforated plate (2a), a second perforated transverse plate (2b) made of an electrically conductive material fixed to the upstream side of the first perforated wall (3), a second perforated transverse wall (3b) made of an electrically insulating material and opaque to the electromagnetic signals fixed to the upstream side of the second perforated plate (2b) and a third perforated transverse wall (32) parallel to the first perforated plate (2a) and axially spaced from the latter to delimit the confinement chamber, the third perforated wall made of an electrically insulating material and opaque to the electromagnetic signals, and situated at the downstream end of the treatment chamber (40) to allow the gas stream to leave through the third perforated wall,
(b) a means (4) for generating a first uniform magnetic field (B1), the vector representing this first magnetic field (B1) being parallel to the longitudinal axis X-X′ of the treatment chamber (40), this longitudinal axis X-X′ passing through the center of the first perforated plate (2) and the third perforated wall (32),
(c) a means (5) for generating, in the treatment chamber (40), a second uniform magnetic field (B2) in the first uniform magnetic field (B1), the vector representing the second magnetic field (B2) being parallel to and having the same direction as the vector representing the first uniform magnetic field (B1),
(d) a means (6, 7) for emitting an electromagnetic signal (EM1) in the gaseous medium of the treatment chamber (40) to produce free electrons in this gaseous medium, by the application to this means (6, 7) of at least one alternating voltage (V6; V7),
(e) a means (9, 10) for generating a first uniform electrical field (E1) in the plasma, by the application to this means (9, 10) of at least one alternating voltage (V6; V7), the amplitude and the frequency of which can be variable and the axis on which is located the vector representing the first uniform electrical field (E1) being perpendicular to the longitudinal axis X-X′ of the treatment chamber (40),
(f) a means (12, 13) for generating one or more second electrical fields (E2) in the plasma, by the application to this means (12, 13) of a first alternating voltage (V6) and the axis on which is located the vector representing each second electrical field (E2) not being parallel to the axis on which is located the vector representing the first uniform electrical field (E1),
(g) a powering system (14) controlling the value of the first and second uniform magnetic fields (B1, B2), the frequency and the amplitude of the alternating voltages (V6; V7) and of the first alternating voltage (V6), this powering system (14) being used to generate
(i) an electron cyclotron resonance (ECR) wherein the axis of the centripetal acceleration orbit of the electrons and of the charged particles is parallel to the axis X-X′ of the treatment chamber (40) (ii) of the electron cyclotron resonances (ECR), wherein the axes of the centripetal acceleration orbits of the electrons and of the charged particles oscillate gyromagnetically.

44. The device as claimed in claim 41, wherein the electrical power supply means (23) is a mains input source which supplies a mains voltage (V4) of approximately 220 V at a frequency of approximately 50 hertz.

45. The device as claimed in claim 41, wherein the powering system (14) comprises:
(a) an electrical power supply means (23) for this powering system (14) delivering an alternating voltage (V4),
(b) a means (35) for transforming the alternating voltage (V4) from the input source (23) into an intermediate alternating voltage (V5),
(c) a means (36) for varying the frequency of the intermediate alternating voltage (V5), and
(d) a means (28) for transforming this intermediate alternating voltage (V5) into the first and second output alternating voltages (V6; V7), and into the output current (I1).

46. The device as claimed in claim 45, wherein the value of the intermediate alternating voltage (V5) is between approximately 10 and 50 volts.

47. The device as claimed in claim 45, wherein the value of the first and second alternating voltages (V6; V7) is between 1 and 30 kilovolts at a frequency of between 5 hertz and 10 kilohertz for a power of between 1 and 30 watts.

48. The device as claimed in claim 45, wherein the means (28) for transforming the intermediate alternating voltage (V5) into the first and second alternating voltages (V6; V7) is a transformer (28), the impedance of which is adapted automatically and with no loss of power to the varying impedance of the device.

49. The device as claimed in claim 41, wherein the value of the current (I1) is between 1 microAmp and 0.1 Amp.

50. The device as claimed in claim 41, wherein the value of the first and second alternating voltages (V6; V7) is approximately 15 kilovolts for an output power of approximately 100 watts.

51. The device as claimed in claim 41, wherein the gaseous medium comprises a stream of ambient air or of any other gaseous medium at ambient temperature and atmospheric pressure, and wherein this gaseous medium is charged with any combination of inert particles, non-biological organic particles, contaminant inorganic particles, biological particles such as bacteria, bacterial spores, fungi, fungal spores and/or viruses, and wherein these particles are destroyed or transformed during their passage through the treatment chamber (40) before leaving the treatment chamber (40).

52. The device as claimed in claim 41, which comprises at least one manual or automatic probing device, this probing device being used to provide information concerning the presence of the various types of contaminants, this information being transmitted manually or automatically to a control device coupled to the power supply (14), this control device being used to modulate the alternating voltage (V6; V7) and/or the current (I1) according to the level of contamination at the device inlet.
